(19) United States
(12) Patent Application Publication
(10) Pub. No.: US 2019/0140862 A1
(43) Pub. Date: May 9, 2019

(54) METHOD FOR EXCHANGING DATA IN CLUSTER SERVER SYSTEM

(71) Applicant: ZHENGZHOU YUNHAI INFORMATION TECHNOLOGY CO., LTD., Zhengzhou, Henan (CN)

(72) Inventor: Tao LIU, Zhengzhou, Henan (CN)

(73) Assignee: ZHENGZHOU YUNHAI INFORMATION TECHNOLOGY CO., LTD., Zhengzhou, Henan (CN)

(21) Appl. No.: 16/096,597

(22) PCT Filed: Jul. 20, 2017
(86) PCT No.: PCT/CN2017/093619

§ 371 Date: Oct. 25, 2018

(30) Foreign Application Priority Data
Dec. 14, 2016 (CN) 201611156451.X

(51) Int. Cl. H04L 12/42; H04L 12/937; H04L 29/08; H04L 29/12; H04L 12/935

(52) U.S. Cl. CPC H04L 12/42; H04L 49/253; H04L 2012/421; H04L 61/6022; H04L 49/30; H04L 67/1008

(57) ABSTRACT

A method for exchanging data in a cluster server system is provided. In the cluster server system, data is exchanged between adjacent nodes by transmission of packet data with an embedded address of a server node between different nodes, and the data is forwarded between non-adjacent nodes by a data exchange control unit. The method includes: establishing a dual-network port data exchange control unit in a server node in the cluster server system; establishing a transmission control mechanism for node data of the server node in the cluster server system; establishing a forwarding control mechanism for the node data of the server node in the cluster server system; establishing a linking loop of server nodes in the cluster server system; and establishing node load automatic balancing of the server nodes in the cluster server system.

### FIELD

The present disclosure relates to the field of computer communication, and in particular to a method for exchanging data in a cluster server system, which aims to solve problems of low maintenance efficiency and insufficient system cost advantage in data exchange design of server nodes in a conventional cluster system, so as to ensure the efficient operation of the cluster server system and achieve an efficient and low-cost data network exchange in an actual data exchange of the cluster server system.

### BACKGROUND

In a conventional cluster server system, in order to give full play to the computing and resource advantages of the server cluster, it is required to perform data transmission between server nodes in the server cluster. In order to exchange and transmit the data between the server nodes, a manner in which a switch is installed in the cluster server is generally used presently. That is, a multi-port switch is installed in the cluster server, and each server node is directly connected to the multi-port switch. As the applications of the server node increase, demand and dependence on the switch increase. Therefore, the method for exchanging data between server nodes of the cluster server system becomes one of the key factors affecting the stability and efficient operation of the system. The switch is a kernel device in the cluster system. In a case where the switch is in a fault state and is required to be replaced, it is required to stop the entire cluster system before replacing the faulty device. Therefore, the uninterrupted operation and maintenance of the cluster system cannot be achieved.

The data exchanging method of the conventional cluster server system has the following disadvantages. First, the online seamless maintenance of the cluster server system cannot be ensured; in a case where the switch device is in a fault state, it is required to stop the service operation of the cluster server system, which seriously affects the operation efficiency of the cluster server system. Secondly, the position of the switch device is fixed; in a case where all nodes are connected to the switch, it is required to perform the connection one-to-one, and the wiring density in the network space is high, resulting in a high overall cost of the network. For a lightweight system switching application, the cost of the cluster server system does not have a clear advantage.

In view of the problem of the low maintenance efficiency and insufficient system cost advantage in the server node data exchange design of the conventional cluster server system, in order to ensure the efficient operation of the cluster system, a method of adopting an efficient and low-cost data network exchange in the actual cluster server system is one of the key factors determining the advantages of a cluster system.

A method for exchanging data in a cluster server system is provided according to the present disclosure in combination with the key electrical factors such as the data network link signal operating characteristic. The method includes: establishing a dual-network port data exchange control unit in each of the server nodes in the cluster server system. With the dual-network port data exchange control unit, adjacent server nodes in the cluster system are cascaded in sequence, and data can be transmitted between the nodes through packet data with an embedded address of the server node. When the data is exchanged between adjacent nodes, the data is forwarded between non-adjacent nodes by the data exchange control unit, thereby ensuring the flexibility of the system.

### Technical Problem

The disclosure is based on the data exchange design principle. Specifically, the problems of low maintenance efficiency and insufficient system cost advantage in data exchange design of the server nodes in the conventional cluster server system are solved using the method for exchanging data in the cluster server system.

### SUMMARY

### Solution to the Problem

### Technical Solution

The following technical solutions are provided according to the present disclosure.

A method for exchanging data in a cluster server system is provided. In the cluster server system, data is exchanged between adjacent nodes by transmission of packet data with an embedded address of a server node between different nodes, and the data is forwarded between non-adjacent nodes by a data exchange control unit. The method for exchanging data in a cluster server system includes: establishing a dual-network port data exchange control unit in a server node in the cluster server system; establishing a transmission control mechanism for node data of the server node in the cluster server system; establishing a forwarding control mechanism for the node data of the server node in the cluster server system; establishing a linking loop of server nodes in the cluster server system; and establishing node load automatic balancing of the server nodes in the cluster server system.

In the method for exchanging data in a cluster server system described above, the dual-network port data exchange control unit is established by using an FPGA chip MachXO, the dual-network port data exchange control unit is configured to provide two network ports meeting an MDI electrical standard, and the two network ports have different MAC addresses and forward and transmit data independently.

In the method for exchanging data in a cluster server system described above, the transmission control mechanism is used to control the dual-network port data exchange control unit to transmit data transmitted by a CPU to another node through the network port, and the transmitted data includes a MAC address of a data exchange control unit in a target receiving node, to ensure an accurate establishment of a data link.

In the method for exchanging data in a cluster server system described above, the forwarding control mechanism is used to control the dual-network port data exchange control unit to receive data transmitted by an adjacent server node and determine a target MAC address for data transmission, until a target receiving node is found.

In the method for exchanging data in a cluster server system described above, the linking loop is configured to implement a communication among network ports AB of server nodes in the cluster, to connect physical transmission channels between nodes successively by neighboring nodes.

In the method for exchanging data in a cluster server system described above, the node load automatic balancing is achieved by the following balancing method: in a case where it is required to transmit data by a current server node, the current server node transmits a task request data packet to all MAC addresses in the cluster, to confirm a load utilization of each of nodes in the cluster system, and selects a MAC of a node with the smallest load utilization in the cluster system as a target receiving MAC, to establish a transmission link between a source end and a target end.

In the method for exchanging data in a cluster server system described above, the dual-network port data exchange control unit is connected to a PCIE signal of a motherboard, to implement a PCIE link communication with a CPU on the motherboard.

In the method for exchanging data in a cluster server system described above, in an initialization process of the cluster system, MAC addresses of the data exchange control units in all server nodes in the cluster system are aggregated into a table, and the table is stored in a EEPROM chip of each of the data exchange control units in all the server nodes in the cluster.

In the method for exchanging data in a cluster server system described above, the forwarding control mechanism is used to receive data transmitted by an adjacent server node, recognize a MAC address of a target node contained in the data, and determine whether the MAC address of the target node is consistent with a MAC address of a current node. If the MAC address of the target node is consistent with the MAC address of the current node, the data transmitted by the adjacent server node is received by the current node; and if the MAC address of the target node is inconsistent with the MAC address of the current node, the data transmitted by the adjacent server node is transmitted to a next server node, and the next node performs the same determination on a target address of the data, until the target receiving node is found.

In the method for exchanging data in a cluster server system described above, the linking loop is configured to achieve a communication among network ports AB of server nodes in the cluster. That is, a network port B of the data exchange control unit in a first server node is linked to a network port A of the data exchange control unit of a next adjacent node through a Gigabit network cable, and a network port B of the data exchange control unit of the next adjacent node is linked to a network port A of the data exchange control unit of a following node; the process is performed in sequence, and a network port B of a last server node is linked to a network port A of the data exchange control unit in the first server node, to establish the linking loop of the server nodes in the cluster.

### Beneficial Effects of the Present Disclosure

### BRIEF DESCRIPTION OF THE DRAWINGS

FIG. 1 shows a linking loop of cluster server nodes; and

FIG. 2 shows a flow chart of an implementation of a cluster server system.

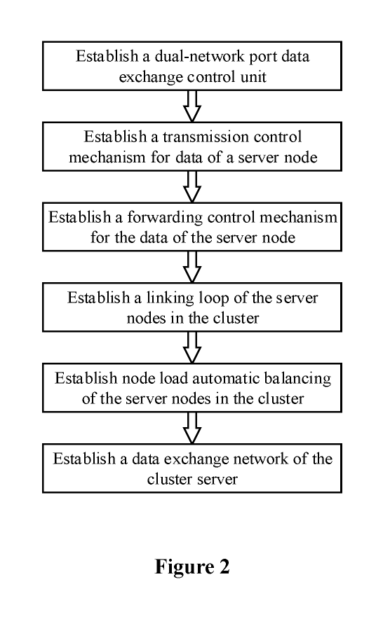

### DETAILED DESCRIPTION

### Embodiments

The contents of the present disclosure are explained in detail below.

A method for exchanging data in a cluster server system is provided according to the present disclosure. In the cluster server system, data is exchanged between adjacent nodes by transmission of packet data with an embedded address of a server node between different nodes, and the data is forwarded between non-adjacent nodes by a data exchange control unit.

First, a dual-network port data exchange control unit is established in a server node by using an FPGA chip MachXO, and a PCIE signal of a motherboard is connected to the dual-network port data exchange control unit. A communication with a CPU is achieved based on a PCIE protocol simulation and a network protocol simulation. The dual-network port data exchange control unit provides two network ports meeting an MDI electrical standard, and the two network ports have different MAC addresses, which are stored in a EEPROM of the FPGA.

Secondly, a transmission control mechanism for node data of a server node is established to control the dual-network port data exchange control unit in the server node to transmit data transmitted by the CPU to another node through the network port. In an initialization process of the system, MAC addresses of the data exchange control units in all server nodes in the cluster are aggregated into a table, and the table is stored in a EEPROM chip of each of the data exchange control units in all the server nodes in the cluster.

Then, a forwarding control mechanism for the node data of the server node is established to control the dual-network port data exchange control unit in the server node to receive data transmitted by an adjacent server node, recognize a MAC address of a target node contained in the data, determine whether the MAC address of the target node is consistent with a MAC address of a current node. If the MAC address of the target node is inconsistent with the MAC address of the current node, the data transmitted by the adjacent server node is transmitted to a next server node, and the next server node performs the same determination on a target address of the data, until the target receiving node is found.

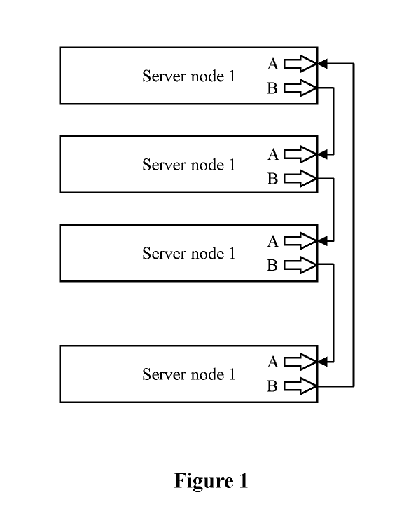

Then, as shown in FIG. 1, a linking loop of server nodes in the cluster is established to achieve a communication among the network ports AB of the server nodes in the cluster. That is, the server nodes in the cluster are connected successively, and physical transmission channels between nodes are connected successively by adjacent nodes.

Finally, node load automatic balancing is established in the cluster server to ensure that a target task can be efficiently executed, thereby realizing an optimal performance configuration of the entire cluster. That is, in a case where it is required to transmit data by a current server node, the current server node transmits a task request data packet to all MAC addresses in the cluster, to confirm a load utilization of each of nodes in the cluster system, and selects a MAC of a node with the smallest load utilization in the cluster system as a target receiving MAC to establish a transmission link between a source end and a target end, thereby realizing the node load automatic balancing of the cluster.

With the above detailed embodiments, the data exchange between the cluster server nodes can be achieved conveniently, thereby not only meeting the reliability requirement, but also meeting the low cost requirement, and thus achieving high reliable and lightweight applications of the cluster server system.

1. A method for exchanging data in a cluster server system, wherein in the cluster server system, data is exchanged between adjacent nodes by transmission of packet data with an embedded address of a server node between different nodes, and the data is forwarded between non-adjacent nodes by a data exchange control unit, and wherein the method for exchanging data in a cluster server system comprises:
establishing a dual-network port data exchange control unit in a server node in the cluster server system;
establishing a transmission control mechanism for node data of the server node in the cluster server system;
establishing a forwarding control mechanism for the node data of the server node in the cluster server system;
establishing a linking loop of server nodes in the cluster server system; and
establishing node load automatic balancing of the server nodes in the cluster server system.

2. The method for exchanging data in a cluster server system according to claim 1, wherein the dual-network port data exchange control unit is established by using an FPGA chip MachXO, the dual-network port data exchange control unit is configured to provide two network ports meeting an MDI electrical standard, and the two network ports have different MAC addresses and forward and transmit data independently.

3. The method for exchanging data in a cluster server system according to claim 2, wherein the transmission control mechanism is used to control the dual-network port data exchange control unit to transmit data transmitted by a CPU to another node through the network port, and the transmitted data comprises a MAC address of a data exchange control unit in a target receiving node, to ensure accurate establishment of a data link.

4. The method for exchanging data in a cluster server system according to claim 3, wherein the forwarding control mechanism is used to control the dual-network port data exchange control unit to receive data transmitted by an adjacent server node and determine a target MAC address for data transmission, until the target receiving node is found.

5. The method for exchanging data in a cluster server system according to claim 4, wherein the linking loop is configured to implement a communication among network ports A/B of server nodes in the cluster, to connect physical transmission channels between nodes successively by adjacent nodes.

6. The method for exchanging data in a cluster server system according to claim 5, wherein the node load automatic balancing is achieved by the following balancing method: in a case where it is required to transmit data by a current server node, the current server node transmits a task request data packet to all MAC addresses in the cluster to confirm a load utilization of each of nodes in the cluster system, and selects a MAC of a node with the smallest load utilization in the cluster system as a target receiving MAC to establish a transmission link between a source end and a target end.

7. The method for exchanging data in a cluster server system according to claim 4, wherein the dual-network port data exchange control unit is connected to a PCIE signal of a motherboard, to implement a PCIE link communication with a CPU on the motherboard.

8. The method for exchanging data in a cluster server system according to claim 1, wherein in an initialization process of the cluster system, MAC addresses of the data exchange control units in all server nodes in the cluster system are aggregated into a table, and the table is stored in a EEPROM chip of each of the data exchange control units in all the server nodes in the cluster.

9. The method for exchanging data in a cluster server system according to claim 1, wherein the forwarding control mechanism is used to receive data transmitted by an adjacent server node, recognize a MAC address of a target node contained in the data, and determine whether the MAC address of the target node is consistent with a MAC address of a current node; and wherein
if the MAC address of the target node is consistent with the MAC address of the current node, the data transmitted by the adjacent server node is received by the current node; and
if the MAC address of the target node is inconsistent with the MAC address of the current node, the data transmitted by the adjacent server node is transmitted to a next server node, and the next node performs the same determination on a target address of the data, until a target receiving node is found.

10. The method for exchanging data in a cluster server system according to claim 1, wherein the linking loop is configured to implement a communication among network ports AB of server nodes in the cluster; and wherein
a network port B of the data exchange control unit in a first server node is linked to a network port A of the data exchange control unit of a next adjacent node through a Gigabit network line, and a network port B of the data exchange control unit of the next adjacent node is linked to a network port A of the data exchange control unit of a following node; the process is performed in sequence, and a network port B of a last server node is linked to a network port A of the data exchange control unit in the first server node, to establish the linking loop of the server nodes in the cluster.
